(19) United States
(12) Patent Application Publication
(10) Pub. No.: US 2022/0132125 A1
(43) Pub. Date: Apr. 28, 2022

(54) VIDEO CODING APPARATUS AND METHOD, VIDEO DECODING APPARATUS AND METHOD AND VIDEO CODEC SYSTEM

(71) Applicant: Fujitsu Limited, Kawasaki-shi (JP)

(72) Inventors: Jie YAO, Beijing (CN); Jianqing ZHU, Beijing (CN)

(73) Assignee: Fujitsu Limited, Kawasaki-shi (JP)

(21) Appl. No.: 17/481,319

(22) Filed: Sep. 22, 2021

(30) Foreign Application Priority Data
Oct. 23, 2020 (CN) 202011143196.1

(51) Int. Cl. H04N 19/124; H04N 19/42; H04N 19/85; H04N 19/184

(52) U.S. Cl. CPC H04N 19/124; H04N 19/184; H04N 19/85; H04N 19/42

(57) ABSTRACT

Embodiments of this disclosure provide a video coding apparatus and method, a video decoding apparatus and method and a video codec system. The video coding method includes: converting an integer-type 3D image feature into a 2D image sequence; and compressing the 2D image sequence to obtain a compressed bit stream.

### CROSS-REFERENCE TO RELATED APPLICATION

This application claims the benefit of priority to Application No. 202011143196.1, filed in China on Oct. 23, 2020, the contents of which are incorporated by reference in their entirety.

### TECHNICAL FIELD

This disclosure relates to the field of information technologies.

### BACKGROUND

With the rise of machine-learning applications, machine vision has replaced human vision in many AI applications, such as connected vehicles, video surveillance, and smart cities.

Conventional coding methods (H.26x) are dedicated to obtaining the best videos and images under certain bit rate constraints. This has become the driving force that requires more compact data representation and low-latency compression solutions. In this case, MPEG video coding for machines (VCM) is established, with a purpose of standardizing bitstream formats generated by feature streams (for use by machines) and optional video streams (for use by people) extracted from video by compressing.

FIG. 1 is a schematic diagram of an existing VCM system. As shown in FIG. 1, a video or feature is inputted into a VCM coder to obtain a compressed bit stream, the bit stream is inputted into a VCM decoder to obtain a decompressed video or feature, and the decompressed video or feature is inputted into an analysis module for task analysis of machine vision and/or human vision.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

The machine vision task is a main goal of the VCM. More and more machine vision systems have used convolutional neural networks (CNNs) to perform feature extraction for different tasks, such as object detection and tracking. A convolutional neural network is used to extract features from data collected by a sensor and output intermediate image features. As the image features outputted by the convolutional neural network are three-dimensional features, such as a three-dimensional shape tensor (3D shape tensor), it is impossible to directly use an existing video codec to code and decode the image features outputted by the convolutional neural network. Therefore, how to effectively compress the intermediate feature data is a key problem needing to be solved by the VCM.

In order to solve at least one of the above problems, embodiments of this disclosure provide a video coding apparatus and method, a video decoding apparatus and method and a video codec system, which may directly use an existing video codec, and effectively compress intermediate feature data.

According to a first aspect of the embodiments of this disclosure, there is provided a video coding apparatus, the video coding apparatus including: a first converting unit configured to convert an integer-type three-dimensional image feature into a two-dimensional image sequence; and a first coding unit configured to compress the two-dimensional image sequence to obtain a compressed bit stream.

According to a second aspect of the embodiments of this disclosure, there is provided a video decoding apparatus, the video decoding apparatus including: a decoding unit configured to decompress a received bit stream to obtain a two-dimensional image sequence; and a reconstructing unit configured to reconstruct the two-dimensional image sequence to obtain an integer-type three-dimensional image feature.

According to a third aspect of the embodiments of this disclosure, there is provided an electronic device, including the video coding apparatus as described in the first aspect of the embodiments of this disclosure.

According to a fourth aspect of the embodiments of this disclosure, there is provided an electronic device, including the video decoding apparatus as described in the second aspect of the embodiments of this disclosure.

According to a fifth aspect of the embodiments of this disclosure, there is provided a video codec system, the video codec system including a coder and a decoder, the coder including the video coding apparatus as described in the first aspect of the embodiments of this disclosure, and the decoder including the video decoding apparatus as described in the second aspect of the embodiments of this disclosure.

According to a sixth aspect of the embodiments of this disclosure, there is provided a video coding method, the video coding method including: converting an integer-type three-dimensional image feature into a two-dimensional image sequence; and compressing the two-dimensional image sequence to obtain a compressed bit stream.

According to a seventh aspect of the embodiments of this disclosure, there is provided a video decoding method, the video decoding method including: decompressing a received bit stream to obtain a two-dimensional image sequence; and reconstructing the two-dimensional image sequence to obtain an integer-type three-dimensional image feature.

An advantage of the embodiments of this disclosure exists in that by converting the integer-type 3D image feature into a 2D image sequence, an existing video codec may be directly used, and intermediate feature data may be effectively compressed.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising/includes/including” when used in this specification is taken to specify the presence of stated features, integers, steps or components but does not preclude the presence or addition of one or more other features, integers, steps, components or groups thereof.

### BRIEF DESCRIPTION OF THE DRAWINGS

The drawings are included to provide further understanding of this disclosure, which constitute a part of the specification and illustrate the preferred embodiments of this disclosure, and are used for setting forth the principles of this disclosure together with the description. It is obvious that the accompanying drawings in the following description are some embodiments of this disclosure, and for those of ordinary skills in the art, other accompanying drawings may be obtained according to these accompanying drawings without making an inventive effort. In the drawings:

FIG. 1 is schematic diagram of an existing VCM system;

FIG. 2 is a schematic diagram of the video coding apparatus of Embodiment 1 of this disclosure;

FIG. 3 is a schematic diagram of the first converting unit 201 of Embodiment 1 of this disclosure;

FIG. 4 is a schematic diagram of the video decoding apparatus of Embodiment 2 of this disclosure;

FIG. 5 is a schematic diagram of the electronic device of Embodiment 3 of this disclosure;

FIG. 6 is a block diagram of a systematic structure of the electronic device of Embodiment 3 of this disclosure;

FIG. 7 is a schematic diagram of the electronic device of Embodiment 4 of this disclosure;

FIG. 8 is a block diagram of a systematic structure of the electronic device of Embodiment 4 of this disclosure;

FIG. 9 is a schematic diagram of the video codec system of Embodiment 5 of this disclosure;

FIG. 10 is a schematic diagram of the video coding method of Embodiment 6 of this disclosure; and

FIG. 11 is a schematic diagram of the video decoding method of Embodiment 7 of this disclosure.

### DETAILED DESCRIPTION OF THE DISCLOSURE

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

The embodiment of this disclosure provides a video coding apparatus, applicable to a side of coding a video.

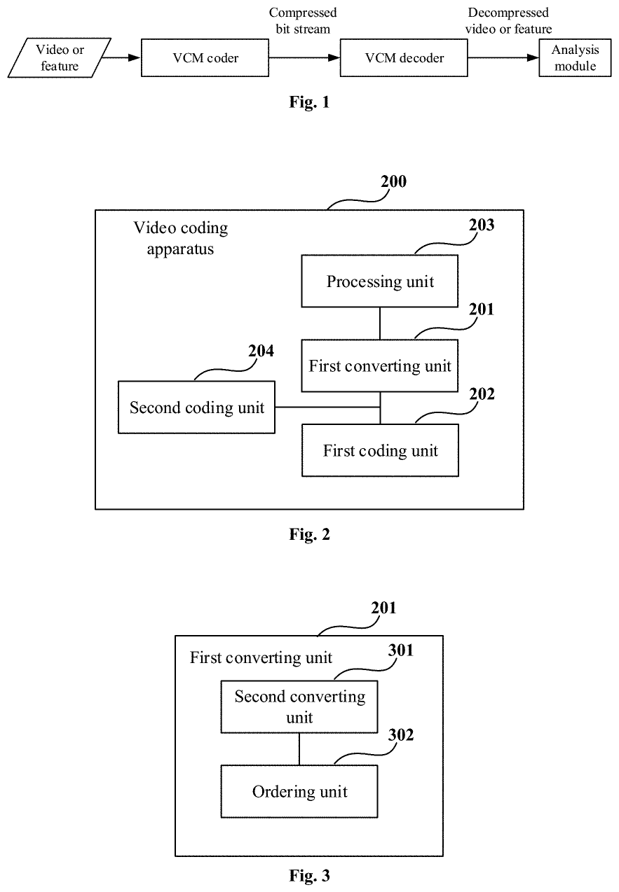

FIG. 2 is a schematic diagram of the video coding apparatus of Embodiment 1 of this disclosure.

As shown in FIG. 2, a video coding apparatus 200 includes:

a first converting unit 201 configured to convert an integer-type 3D image feature into a 2D image sequence; and

a first coding unit 202 configured to compress the 2D image sequence to obtain a compressed bit stream.

In the embodiment of this disclosure, the video coding apparatus 200 may be applicable to various codec systems, such as a video coding for machines (VCM) system.

In the embodiment of this disclosure, the first converting unit 201 is configured to convert the integer-type 3D image feature into a 2D image sequence, that is, when data inputted into the video coding apparatus 200 are integer-type data, the first converting unit 201 may directly perform conversion processing.

In the embodiment of this disclosure, when data inputted into the video coding apparatus 200 are not integer-type data, such as floating-point type data, as shown in FIG. 2, the video coding apparatus 200 may further include:

a processing unit 203 configured to process a floating-point type 3D image feature to obtain the integer-type 3D image feature.

In the embodiment of this disclosure, the floating-point type 3D image feature is, for example, outputted by a convolutional neural network in the VCM system, the convolutional neural network being used to extract features from data collected by a sensor and output intermediate image features.

For example, the floating-point type 3D image feature is floating-point type data of 32 bits.

In the embodiment of this disclosure, the 3D image feature is, for example, a feature in a form of a three-dimensional shape tensor.

In the embodiment of this disclosure, the processing unit 203 may process the floating-point type 3D image feature in various manners so as to obtain the integer-type 3D image feature.

For example, the processing unit 203 performs uniform quantization on the floating-point type 3D image feature.

In the embodiment of this disclosure, reference may be made to related arts for a method for performing uniform quantization processing by the processing unit 203. For example, the processing unit 203 performs uniform quantization processing according to following formula (1):

$$\hat{T} = round ( \frac{T - min ( T )}{max ( T ) - min ( T )} * ( {2}^{n b i t} - 1 ) ) ; \qquad ( 1 )$$

where, \hat{T} denotes a quantized integer-type 3D image feature, T denotes a floating-point type three-dimensional image feature before quantization, min(T) and max(T) respectively denote a minimum value and a maximum value in T, round ( ) denotes rounding to a nearest integer, and n denotes precision of quantized data, n being a positive integer.

In the embodiment of this disclosure, the precision of quantized data may be set as actually demanded, for example, n is 6 or 8, that is, the precision of data of the integer-type 3D image feature is 8 bits or 10 bits.

In the embodiment of this disclosure, the floating-point type three-dimensional image feature T before quantization may be expressed as T[W, H, C], which denotes that the floating-point type three-dimensional image feature T has W columns, H rows, and C channels.

For example, the floating-point type three-dimensional image feature T before quantization is floating-point type data of 32 bits.

In the embodiment of this disclosure, when uniform quantization processing is needed, min(T) and max(T) are further needed to be coded into a bit stream for performing inverse quantization processing at a decoding side.

For example, min(T) and max(T) are coded into the bit stream in a form of floating-point type data of 32 bits.

When the data inputted into the video coding apparatus 200 are integer-type data or after the floating-point type data are processed into integer-type data by the processing unit 203, the first converting unit 201 converts the integer-type 3D image feature into a two-dimensional image sequence.

In the embodiment of this application, the integer-type 3D image feature \hat{T} may be expressed as \hat{T}[W, H, C], which denotes the integer-type 3D image feature \hat{T} has W columns, H rows, and C channels.

In the embodiment of this disclosure, when the floating-point type data need to be quantized first, data sizes before and after the quantization processing are not changed, and precision of the data is changed.

FIG. 3 is a schematic diagram of the first converting unit 201 of Embodiment 1 of this disclosure. As shown in FIG. 3, the first converting unit 201 includes:

a second converting unit 301 configured to convert the integer-type 3D image feature into a 2D image sequence with a frame number C, C being equal to the number of channels of the integer-type 3D image feature.

That is to say, the second converting unit 301 segments the integer-type 3D image feature having C channels into a 2D image sequence with a frame number C, sizes of frames in the sequence, i.e. 2D images, are W×H.

In the embodiment of this disclosure, as shown in FIG. 3, the first converting unit 201 further includes:

an ordering unit 302 configured to determine orders of images of the channels in the 2D image sequence according to mean values of pixels of the images of the channels.

For example, the ordering unit 302 orders the images of the channels according to an ascending order of the mean values of the pixels of the images of the channels.

That is to say, the ordering unit 302 associates channel numbers of the 3D image feature with frame numbers of the 2D images according to the mean values of the pixels.

For example, the ordering unit 302 first calculates the mean values of the image pixels of the channels, arranges the two-dimensional images of the channels in the ascending order of the average values to obtain the two-dimensional image sequence, and determines the channel numbers to which the frames in the two-dimensional image sequence correspond.

For example, after an image with a channel number N is ordered according to the ascending order of the mean values of the image pixels, it is ranked M-th, that is, the image is an M-th frame in the two-dimensional image sequence, and the channel number to which it corresponds is N, both M and N being positive integers.

In the embodiment of this disclosure, the integer-type 3D image feature processed by the video coding apparatus 200 may be multiple, that is, the video coding apparatus 200 processes a sequence of integer-type 3D image features.

For a sequence of integer-type 3D image features, the ordering unit 302 determines orders of images of the channels in the 2D image sequence for a first integer-type 3D image feature; and the ordering unit 302 uses an order identical to that of the integer-type 3D image feature for other integer-type 3D image features.

That is to say, orders of frames in the two-dimensional image sequence are determined only based on a first integer-type 3D image feature in the sequence of integer-type 3D image features, which can effectively improve the coding efficiency.

In the embodiment of this disclosure, for example, as shown in FIG. 2, the video coding apparatus 200 further includes:

a second coding unit 204 configured to, for the first integer-type 3D image feature in the sequence of integer-type 3D image features, code channel numbers to which frames of the 2D image sequence correspond into the bit stream.

In this way, at the decoding side, the channel numbers to which the frames of the two-dimensional image sequence correspond obtained by decoding may be used for feature reconstruction processing.

In the embodiment of this disclosure, the first coding unit 202 compresses the two-dimensional image sequence outputted by the first converting unit 201 to obtain a compressed bit stream.

In the embodiment of this disclosure, various existing coders may be used by the first coding unit 202.

For example, the first coding unit 202 uses a versatile video coding (VVC) standard to compress and code the two-dimensional image sequence. In this way, a coding efficiency may further be improved.

It can be seen from the above embodiment that by converting the integer-type 3D image feature into a 2D image sequence, an existing video codec may be directly used, and intermediate feature data may be effectively compressed.

### Embodiment 2

The embodiment of this disclosure provides a video decoding apparatus, applicable to a side of decoding a video. The video decoding apparatus is one corresponding to the video coding apparatus described in Embodiment 1, and reference may be to what is described in Embodiment 1 for identical or similar parts thereof.

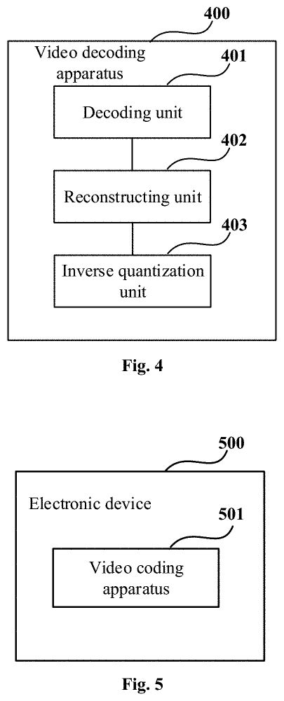

FIG. 4 is a schematic diagram of the video decoding apparatus of Embodiment 2 of this disclosure.

As shown in FIG. 4, a video decoding apparatus 400 includes:

a decoding unit 401 configured to decompress a received bit stream to obtain a 2D image sequence; and

a reconstructing unit 402 configured to reconstruct the 2D image sequence to obtain an integer-type 3D image feature.

In the embodiment of this disclosure, the decoding unit 401 may use an existing decoder for decompression, such as using a versatile video coding (VVC) standard for decompression.

In the embodiment of this disclosure, the reconstructing unit 402 is used to reconstruct the decompressed 2D image sequence to obtain the integer-type 3D image feature.

In the embodiment of this disclosure, the reconstructing unit 402 reconstructs the 2D image sequence according to channel numbers to which frames of the 2D image sequence obtained by decompression correspond to obtain the integer-type 3D image feature, such as a three-dimensional shape tensor.

For example, precision of the data of the integer-type 3D image feature is 8 bits or 10 bits.

In some cases, a floating-point type 3D image feature needs to be obtained. For example, the floating-point type 3D image feature needs to be inputted into another convolutional neural network for task analysis.

In these cases, as shown in FIG. 4, the video decoding apparatus 400 may further include:

an inverse quantization unit 403 configured to perform inverse quantization processing on the integer-type 3D image feature to obtain a floating-point type 3D image feature.

In the embodiment of this disclosure, the inverse quantization unit 403 may use various methods to perform inverse quantization processing, such as performing inverse quantization processing according to following formula (2):

$${T}_{i n v} = \frac{\hat{T} * ( max ( T ) - min ( T ) )}{{2}^{nbit} - 1} + min ( T ) ; \qquad ( 2 )$$

where, \hat{T} denotes a quantized integer-type 3D image feature, Tᵢₙᵥ denotes an inversely quantized floating-point type 3D image feature, min(T) and max(T) respectively denote a minimum value and a maximum value in T, and n denotes precision of quantized data, n being a positive integer.

In the embodiment of this disclosure, min(T) and max(T) are coded into the bit stream at a coding side, and are obtained by decompression by the decoding unit 401.

It can be seen from the above embodiment that by converting the integer-type 3D image feature into a 2D image sequence, an existing video codec may be directly used, intermediate feature data may be effectively compressed, and the 3D image feature is obtained by decompression at the decoding side.

### Embodiment 3

The embodiment of this disclosure provides an electronic device. FIG. 5 is a schematic diagram of the electronic device of Embodiment 3 of this disclosure. As shown in FIG. 5, an electronic device 500 includes a video coding apparatus 501, a structure and function of the video coding apparatus 501 being identical those described in Embodiment 1, and being not going to be described herein any further.

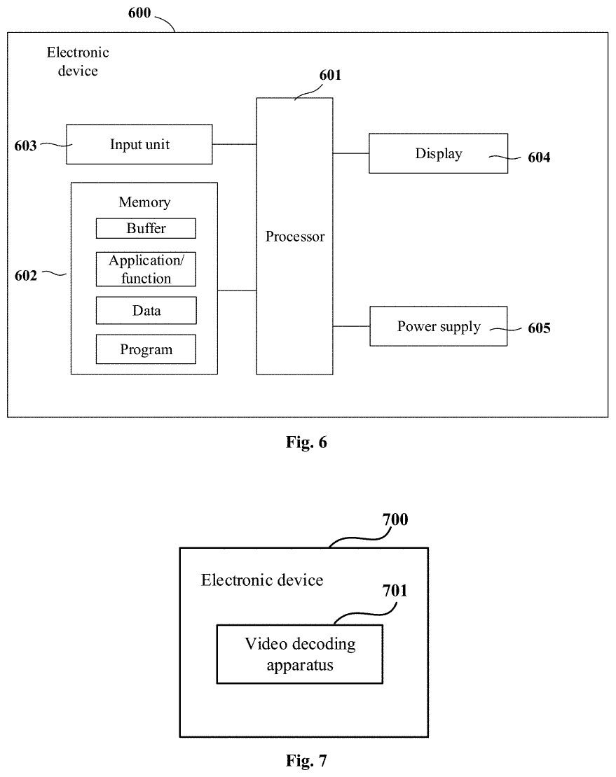

FIG. 6 is a schematic diagram of a systematic diagram of the electronic device of Embodiment 3 of this disclosure. As shown in FIG. 6, an electronic device 600 may include a processor 601 and a memory 602, the memory 602 being coupled to the processor 601. This figure is illustrative only, and other types of structures may also be used, so as to supplement or replace this structure and achieve a telecommunications function or other functions.

As shown in FIG. 6, the electronic device 600 may further include an input unit 603, a display 604, and a power supply 605.

In one implementation, the functions of the video coding apparatus described in Embodiment 1 may be integrated into the processor 601. The processor 601 may be configured to: convert an integer-type 3D image feature into a 2D image sequence, and compress the 2D image sequence to obtain a compressed bit stream.

For example, the processor 601 may further be configured to: process a floating-point type 3D image feature to obtain the integer-type 3D image feature.

For example, the processing a floating-point type 3D image feature includes: performing uniform quantization on the floating-point type 3D image feature.

For example, the converting an integer-type 3D image feature into a 2D image sequence includes: converting the integer-type 3D image feature into a 2D image sequence with a frame number C, C being equal to the number of channels of the integer-type 3D image feature.

For example, the converting an integer-type 3D image feature into a 2D image sequence further includes: determining orders of images of the channels in the 2D image sequence according to mean values of pixels of the images of the channels.

For example, the determining orders of images of the channels in the 2D image sequence according to mean values of pixels of the images of the channels includes: ordering the images of the channels according to ascending order of the mean values of the pixels of the images of the channels.

For example, the ordering the images of the channels according to ascending order of the mean values of the pixels of the images of the channels includes: for a sequence of integer-type 3D image features, determining orders of images of the channels in the 2D image sequence for a first integer-type 3D image feature, and using an order identical to that of the integer-type 3D image feature for other integer-type 3D image features.

For example, the processor 601 may further be configured to: for the first integer-type 3D image feature in the sequence of integer-type 3D image features, code channel numbers to which frames of the 2D image sequence correspond into the bit stream.

For example, the compressing the 2D image sequence includes: using a versatile video coding (VVC) standard to compress the two-dimensional image sequence.

For example, precision of data of the integer-type 3D image feature is 8 bits or 10 bits.

For example, the 3D image feature is a feature in a form of a three-dimensional shape tensor.

In another implementation, the video coding apparatus described in Embodiment 1 and the processor 601 may be configured separately. For example, the video coding apparatus may be configured as a chip connected to the processor 601, and the functions of the video coding apparatus are executed under control of the processor 601.

In this embodiment, the electronic device 600 does not necessarily include all the parts shown in FIG. 6.

As shown in FIG. 6, the processor 601 is sometimes referred to as a controller or an operational control, which may include a microprocessor or other processor devices and/or logic devices. The processor 601 receives input and controls operations of components of the electronic device 600.

The memory 602 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 601 may execute programs stored in the memory 602, so as to realize information storage or processing, etc. Functions of other parts are similar to those of the related art, which shall not be described herein any further. The parts of the electronic device 600 may be realized by specific hardware, firmware, software, or any combination thereof, without departing from the scope of this disclosure.

It can be seen from the above embodiment that by converting the integer-type 3D image feature into a 2D image sequence, an existing video codec may be directly used, and intermediate feature data may be effectively compressed.

### Embodiment 4

The embodiment of this disclosure provides an electronic device. FIG. 7 is a schematic diagram of the electronic device of Embodiment 4 of this disclosure. As shown in FIG. 7, an electronic device 700 includes a video decoding apparatus 701, a structure and function of the video decoding apparatus 701 being identical those described in Embodiment 2, and being not going to be described herein any further.

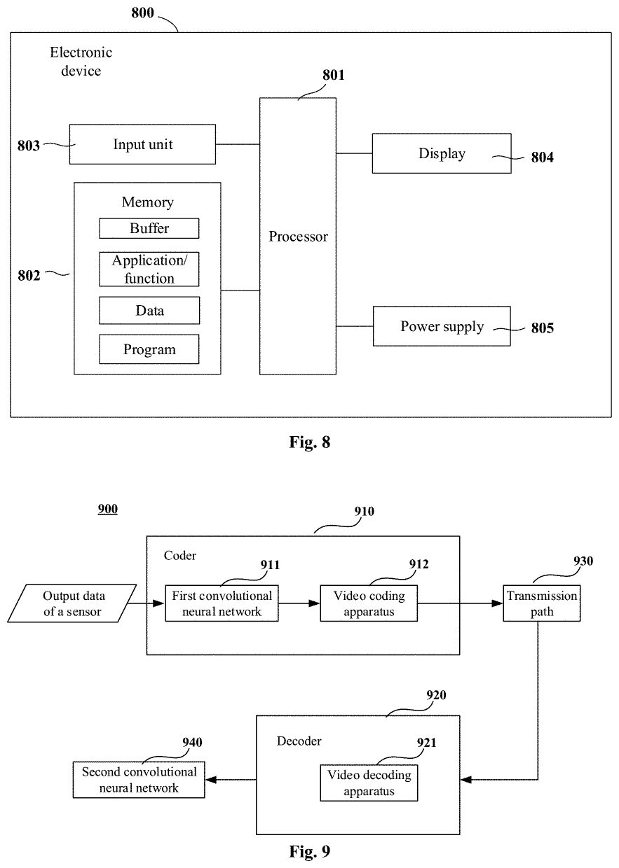

FIG. 8 is a schematic diagram of a systematic diagram of the electronic device of Embodiment 4 of this disclosure. As shown in FIG. 8, an electronic device 800 may include a processor 801 and a memory 802, the memory 802 being coupled to the processor 801. This figure is illustrative only, and other types of structures may also be used, so as to supplement or replace this structure and achieve a telecommunications function or other functions.

As shown in FIG. 8, the electronic device 800 may further include an input unit 803, a display 804, and a power supply 805.

In one implementation, the functions of the video decoding apparatus described in Embodiment 2 may be integrated into the processor 801. The processor 801 may be configured to: decompress a received bit stream to obtain a 2D image sequence, and reconstruct the 2D image sequence to obtain an integer-type 3D image feature.

For example, the processor 801 may further be configured to: perform inverse quantization processing on the integer-type 3D image feature to obtain a floating-point type 3D image feature.

For example, the reconstructing the 2D image sequence includes:

reconstructing the 2D image sequence according to channel numbers to which frames of the 2D image sequence obtained by decompression correspond.

For example, precision of data of the integer-type 3D image feature is 8 bits or 10 bits.

For example, the 3D image feature is a feature in a form of a three-dimensional shape tensor.

In another implementation, the video decoding apparatus described in Embodiment 2 and the processor 801 may be configured separately. For example, the video decoding apparatus may be configured as a chip connected to the processor 801, and the functions of the video decoding apparatus are executed under control of the processor 801.

In this embodiment, the electronic device 800 does not necessarily include all the parts shown in FIG. 8.

As shown in FIG. 8, the processor 801 is sometimes referred to as a controller or an operational control, which may include a microprocessor or other processor devices and/or logic devices. The processor 801 receives input and controls operations of components of the electronic device 800.

The memory 802 may be, for example, one or more of a buffer memory, a flash memory, a hard drive, a mobile medium, a volatile memory, a nonvolatile memory, or other suitable devices, which may store various data, etc., and furthermore, store programs executing related information. And the processor 801 may execute programs stored in the memory 802, so as to realize information storage or processing, etc. Functions of other parts are similar to those of the related art, which shall not be described herein any further. The parts of the electronic device 800 may be realized by specific hardware, firmware, software, or any combination thereof, without departing from the scope of this disclosure.

It can be seen from the above embodiment that by converting the integer-type 3D image feature into a 2D image sequence, an existing video codec may be directly used, intermediate feature data may be effectively compressed, and the 3D image feature is obtained by decompression at the decoding side.

### Embodiment 5

The embodiment of this disclosure provides a video codec system, including a coder and a decoder, the coder including the video coding apparatus described in Embodiment 1, and the decoder including the video decoding apparatus described in Embodiment 2.

FIG. 9 is a schematic diagram of the video codec system of Embodiment 5 of this disclosure. As shown in FIG. 9, a video codec system 900 includes a coder 910, a decoder 920, a transmission path 930 and a second convolutional neural network 940. Collected data of a sensor is inputted into the coder 910 for compression to obtain a compressed bit stream. The compressed bit stream is inputted into the decoder 920 after passing through the transmission path 930, the decoder 920 decompresses the bit stream, and the decompressed data are inputted into the second convolutional neural network 940 for performing machine vision task analysis.

For example, the second convolutional neural network 940 performs task analysis of target detection and/or target tracking.

As shown in FIG. 9, the coder 910 includes:

a first convolutional neural network 911 configured to process the output data of the sensor and output a 3D image feature to be compressed; and

a video coding apparatus 912 configured to compress the 3D image feature to be compressed and output a compressed bit stream.

The decoder 920 includes:

a video decoding apparatus 921 configured to decompress the transmitted compressed bit stream, and output decompressed data, that is, the 3D image feature.

In the embodiment of this disclosure, reference may be made the disclosure contained in Embodiment 1 and Embodiment 2 for particular structures and functions of the video coding apparatus 912 and the video decoding apparatus 921, which shall not be described herein any further.

In the embodiment of this disclosure, various network structures may be used for the first convolutional neural network 911 and the second convolutional neural network 940 as actually demanded.

In the embodiment of this disclosure, the video codec system may be a video coding for machines (VCM) system.

It can be seen from the above embodiment that by converting the integer-type 3D image feature into a 2D image sequence, and an existing video codec may be directly used, intermediate feature data may be effectively compressed.

### Embodiment 6

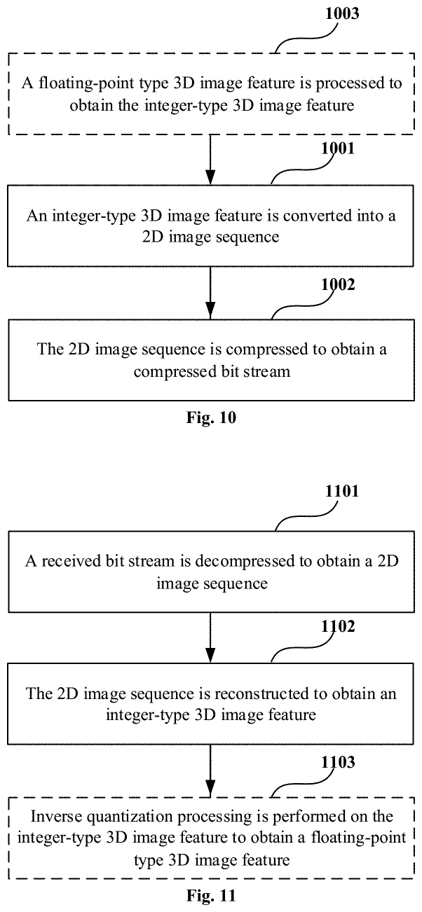

The embodiment of this disclosure provides a video coding method, corresponding to the video coding apparatus in Embodiment 1. FIG. 10 is a schematic diagram of the video coding method of Embodiment 6 of this disclosure. As shown in FIG. 10, the method includes:

Step 1001: an integer-type 3D image feature is converted into a 2D image sequence; and

Step 1002: the 2D image sequence is compressed to obtain a compressed bit stream.

For example, as shown in FIG. 10, the method may further include:

Step 1003: a floating-point type 3D image feature is processed to obtain the integer-type 3D image feature.

In the embodiment of this disclosure, particular implementations of the above steps are identical to those described in Embodiment 1, and shall not be described herein any further.

It can be seen from the above embodiment that by converting the integer-type 3D image feature into a 2D image sequence, and an existing video codec may be directly used, intermediate feature data may be effectively compressed.

### Embodiment 7

The embodiment of this disclosure provides a video decoding method, corresponding to the video decoding apparatus in Embodiment 2. FIG. 11 is a schematic diagram of the video decoding method of Embodiment 7 of this disclosure. As shown in FIG. 11, the method includes:

Step 1101: a received bit stream is decompressed to obtain a 2D image sequence; and

Step 1102: the 2D image sequence is reconstructed to obtain an integer-type 3D image feature.

For example, as shown in FIG. 11, the method may further include:

Step 1103: inverse quantization processing is performed on the integer-type 3D image feature to obtain a floating-point type 3D image feature.

In the embodiment of this disclosure, particular implementations of the above steps are identical to those described in Embodiment 2, and shall not be described herein any further.

It can be seen from the above embodiment that by converting the integer-type 3D image feature into a 2D image sequence, an existing video codec may be directly used, intermediate feature data may be effectively compressed, and the 3D image feature is obtained by decompression at the decoding side.

An embodiment of this disclosure provides a computer readable program, which, when executed in a video coding apparatus or electronic device, will cause a computer to carry out the video coding method as described in Embodiment 6 in the video coding apparatus or electronic device.

An embodiment of this disclosure provides a computer storage medium, including a computer readable program, which will cause a computer to carry out the video coding method as described in Embodiment 6 in a video coding apparatus or electronic device.

An embodiment of this disclosure provides a computer readable program, which, when executed in a video decoding apparatus or electronic device, will cause a computer to carry out the video decoding method as described in Embodiment 7 in the video decoding apparatus or electronic device.

An embodiment of this disclosure provides a computer storage medium, including a computer readable program, which will cause a computer to carry out the video decoding method as described in Embodiment 7 in a video decoding apparatus or electronic device.

Carrying out the video coding method in the video coding apparatus or electronic device described in conjunction with the embodiments of this disclosure may be directly embodied as hardware, software modules executed by a processor, or a combination thereof. For example, one or more functional block diagrams and/or one or more combinations of the functional block diagrams shown in FIG. 2 may either correspond to software modules of procedures of a computer program, or correspond to hardware modules. Such software modules may respectively correspond to the steps shown in FIG. 10. And the hardware module, for example, may be carried out by firming the soft modules by using a field programmable gate array (FPGA).

The soft modules may be located in an RAM, a flash memory, an ROM, an EPROM, and EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, when equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in FIG. 2 may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in FIG. 2 may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

Following supplements are further disclosed in the embodiments of this disclosure.

Paragraph 1. A video coding apparatus, characterized in that the video coding apparatus includes:

a first converting unit configured to convert an integer-type 3D image feature into a 2D image sequence; and

a first coding unit configured to compress the 2D image sequence to obtain a compressed bit stream.

Paragraph 2. The video coding apparatus according to supplement 1, characterized in that the video coding apparatus further includes:

a processing unit configured to process a floating-point type 3D image feature to obtain the integer-type 3D image feature.

Paragraph 3. The video coding apparatus according to supplement 2, characterized in that,

the processing unit performs uniform quantization on the floating-point type 3D image feature.

Paragraph 4. The video coding apparatus according to supplement 1, characterized in that the first converting unit includes:

a second converting unit configured to convert the integer-type 3D image feature into a 2D image sequence with a frame number C, C being equal to the number of channels of the integer-type 3D image feature.

Paragraph 5. The video coding apparatus according to supplement 4, characterized in that the first converting unit further includes:

an ordering unit configured to determine orders of images of the channels in the 2D image sequence according to mean values of pixels of the images of the channels.

Paragraph 6. The video coding apparatus according to supplement 5, characterized in that,

the ordering unit orders the images of the channels according to ascending order of the mean values of the pixels of the images of the channels.

Paragraph 7. The video coding apparatus according to supplement 5, characterized in that,

for a sequence of integer-type 3D image features, the ordering unit determines orders of images of the channels in the 2D image sequence for a first integer-type 3D image feature;

and the ordering unit uses an order identical to that of the integer-type 3D image feature for other integer-type 3D image features.

Paragraph 8. The video coding apparatus according to supplement 7, characterized in that the video coding apparatus further includes:

a second coding unit configured to, for the first integer-type 3D image feature in the sequence of integer-type 3D image features, code channel numbers to which frames of the 2D image sequence correspond into the bit stream.

Paragraph 9. The video coding apparatus according to supplement 1, characterized in that,

the first coding unit uses a versatile video coding (VVC) standard to compress and code the two-dimensional image sequence.

Paragraph 10. The video coding apparatus according to supplement 1, characterized in that, precision of data of the integer-type 3D image feature is 8 bits or 10 bits.

Paragraph 11. The video coding apparatus according to supplement 1, characterized in that,

the 3D image feature is a feature in a form of a three-dimensional shape tensor.

Paragraph 12. A video decoding apparatus, characterized in that the video decoding apparatus includes:

a decoding unit configured to decompress a received bit stream to obtain a 2D image sequence; and

a reconstructing unit configured to reconstruct the 2D image sequence to obtain an integer-type 3D image feature.

Paragraph 13. The video decoding apparatus according to supplement 12, characterized in that the apparatus further includes:

an inverse quantization unit configured to perform inverse quantization processing on the integer-type 3D image feature to obtain a floating-point type 3D image feature.

Paragraph 14. The video decoding apparatus according to supplement 12, characterized in that,

the reconstructing unit reconstructs the 2D image sequence according to channel numbers to which frames of the 2D image sequence obtained by decompression correspond.

Paragraph 15. The video decoding apparatus according to supplement 12, characterized in that,

precision of data of the integer-type 3D image feature is 8 bits or 10 bits.

Paragraph 16. The video decoding apparatus according to supplement 12, characterized in that,

the 3D image feature is a feature in a form of a three-dimensional shape tensor.

Paragraph 17. An electronic device, characterized in that the electronic device includes the video coding apparatus as described in any one of supplements 1-11.

Paragraph 18. An electronic device, characterized in that the electronic device includes the video decoding apparatus as described in any one of supplements 12-16.

Paragraph 19. A video codec system, characterized in that the video codec system includes a coder and a decoder,

the coder including the video coding apparatus as described in any one of supplements 1-11,

and the decoder including the video decoding apparatus as described in any one of supplements 12-16.

Paragraph 20. The video codec system according to supplement 19, characterized in that,

the coder further includes a first convolutional neural network configured to process output data of a sensor and output a 3D image feature to be compressed.

Paragraph 21. The video codec system according to supplement 19, characterized in that the video codec system further includes:

a second convolutional neural network configured to perform machine vision task analysis according to output data of the decoder.

Paragraph 22. The video codec system according to supplement 19, characterized in that,

the video codec system is a video coding for machines (VCM) system.

Paragraph 23. A video coding method, characterized in that the video coding method includes:

converting an integer-type 3D image feature into a 2D image sequence; and

compressing the 2D image sequence to obtain a compressed bit stream.

Paragraph 24. The video coding method according to supplement 23, characterized in that the video coding method further includes:

processing a floating-point type 3D image feature to obtain the integer-type 3D image feature.

Paragraph 25. The video coding method according to supplement 24, characterized in that the processing a floating-point type 3D image feature includes:

performing uniform quantization on the floating-point type 3D image feature.

Paragraph 26. The video coding method according to supplement 23, characterized in that the converting an integer-type 3D image feature into a 2D image sequence includes:

converting the integer-type 3D image feature into a 2D image sequence with a frame number C, C being equal to the number of channels of the integer-type 3D image feature.

Paragraph 27. The video coding method according to supplement 26, characterized in that the converting an integer-type 3D image feature into a 2D image sequence further includes:

determining orders of images of the channels in the 2D image sequence according to mean values of pixels of the images of the channels.

Paragraph 28. The video coding method according to supplement 27, characterized in that the determining orders of images of the channels in the 2D image sequence according to mean values of pixels of the images of the channels includes:

ordering the images of the channels according to ascending order of the mean values of the pixels of the images of the channels.

Paragraph 29. The video coding method according to supplement 27, characterized in that,

for a sequence of integer-type 3D image features, orders of images of the channels in the 2D image sequence for a first integer-type 3D image feature are determined;

and an order identical to that of the integer-type 3D image feature is used for other integer-type 3D image features.

Paragraph 30. The video coding method according to supplement 29, characterized in that the video coding method further includes:

for the first integer-type 3D image feature in the sequence of integer-type 3D image features, coding channel numbers to which frames of the 2D image sequence correspond into the bit stream.

Paragraph 31. The video coding method according to supplement 23, characterized in that the compressing the 2D image sequence includes:

using a versatile video coding (VVC) standard to compress and code the two-dimensional image sequence.

Paragraph 32. The video coding method according to supplement 23, characterized in that,

precision of data of the integer-type 3D image feature is 8 bits or 10 bits.

Paragraph 33. The video coding method according to supplement 23, characterized in that,

the 3D image feature is a feature in a form of a three-dimensional shape tensor.

Paragraph 34. A video decoding method, characterized in that the video decoding method includes:

decompressing a received bit stream to obtain a 2D image sequence; and

reconstructing the 2D image sequence to obtain an integer-type 3D image feature.

Paragraph 35. The video decoding method according to supplement 34, characterized in that the method further includes:

performing inverse quantization processing on the integer-type 3D image feature to obtain a floating-point type 3D image feature.

Paragraph 36. The video decoding method according to supplement 34, characterized in that the reconstructing the 2D image sequence includes:

reconstructing the 2D image sequence according to channel numbers to which frames of the 2D image sequence obtained by decompression correspond.

Paragraph 37. The video decoding method according to supplement 34, characterized in that,

precision of data of the integer-type 3D image feature is 8 bits or 10 bits.

Paragraph 38. The video decoding method according to supplement 34, characterized in that,

the 3D image feature is a feature in a form of a three-dimensional shape tensor.

1. A video coding apparatus, characterized in that the video coding apparatus comprises:
a first converting unit configured to convert an integer-type 3D image feature into a 2D image sequence; and
a first coding unit configured to compress the 2D image sequence to obtain a compressed bit stream.

2. The video coding apparatus according to claim 1, characterized in that the video coding apparatus further comprises:
a processing unit configured to process a floating-point type 3D image feature to obtain the integer-type 3D image feature.

3. The video coding apparatus according to claim 2, characterized in that,
the processing unit performs uniform quantization on the floating-point type 3D image feature.

4. The video coding apparatus according to claim 1, characterized in that the first converting unit comprises:
a second converting unit configured to convert the integer-type 3D image feature into a 2D image sequence with a frame number C, C being equal to the number of channels of the integer-type 3D image feature.

5. The video coding apparatus according to claim 4, characterized in that the first converting unit further comprises:
an ordering unit configured to determine orders of images of the channels in the 2D image sequence according to mean values of pixels of the images of the channels.

6. The video coding apparatus according to claim 5, characterized in that,
the ordering unit orders the images of the channels according to ascending order of the mean values of the pixels of the images of the channels.

7. The video coding apparatus according to claim 5, characterized in that,
for a sequence of integer-type 3D image features, the ordering unit determines orders of images of the channels in the 2D image sequence for a first integer-type 3D image feature;
and the ordering unit uses an order identical to that of the integer-type 3D image feature for other integer-type 3D image features.

8. The video coding apparatus according to claim 7, characterized in that the video coding apparatus further comprises:
a second coding unit configured to, for the first integer-type 3D image feature in the sequence of integer-type 3D image features, code channel numbers to which frames of the 2D image sequence correspond into the bit stream.

9. A video decoding apparatus, characterized in that the video decoding apparatus comprises:
a decoding unit configured to decompress a received bit stream to obtain a 2D image sequence; and
a reconstructing unit configured to reconstruct the 2D image sequence to obtain an integer-type 3D image feature.

10. A video codec system, characterized in that the video codec system comprises a coder and a decoder,
the coder comprising the video coding apparatus as claimed in claim 1, and
a decoder comprising:
a decoding unit configured to decompress a received bit stream to obtain a 2D image sequence; and
a reconstructing unit configured to reconstruct the 2D image sequence to obtain an integer-type 3D image feature.
